(19) United States
(12) Patent Application Publication
(10) Pub. No.: US 2012/0305173 A1
(43) Pub. Date: Dec. 6, 2012

(54) PROCESS FOR MANUFACTURING A CONNECTING ROD MADE OF A COMPOSITE HAVING A LOCALIZED OVERTHICKNESS

(76) Inventors: Richard Masson, Les Loges En Josas (FR); Patrick Dunleavy, Palaiseau (FR)

(21) Appl. No.: 13/514,541

(22) PCT Filed: Dec. 7, 2010
(86) PCT No.: PCT/EP2010/007429

§ 371 Date: Aug. 23, 2012

(30) Foreign Application Priority Data
Dec. 8, 2009 (FR) 09/05927

(51) Int. Cl. B32B 37/12; B32B 38/00

(52) U.S. Cl. 156/185

(57) ABSTRACT

The invention relates to a process for manufacturing a connecting rod (19) made of a composite having one end in the form of a clevis (21). According to the invention, a layer (16a-16e) of reinforcing fibres (14) braided around a mandrel (5) is applied by a braiding machine (12) over the entire length of the mandrel (5); a layer (17a-17d) of reinforcing fibres is then applied by a winding machine around the end (7) (5) corresponding to the clevis (21); other layers of braided fibres (16a-16e) and wound fibres (17a-17d) are applied alternately until constituting a fibre (14) thickness sufficient for the clevis (21) to be formed. Resin is then injected into the various layers (16a-16e, 17a-17d) of braided and wound fibres, the resin then being cured, and the end comprising the wound layers (17a-17d) is machined in order to form thereat the clevis (21).

The invention concerns a method for making a connecting rod made of a composite material including a main body of tubular or analogous type a part of which such as one end features an increased thickness of composite material.

### BACKGROUND OF THE INVENTION

FIG. 1 shows one such connecting rod 1 which comprises a generally tubular hollow main body 2 extended at each of its ends by a double yoke 3, 4.

Each double yoke 3, 4 more particularly comprises two arms 3a, 3b, 4a and 4b all of which are constituted of a thickness of composite material greater than the nominal thickness of composite material in the rest of the connecting rod. The two arms of each yoke lie parallel to the general direction of the hollow main body and each arm comprises a bore fitted with an internal metal ring.

In a method known from the patent document FR2893532, this connecting rod is fabricated entirely in composite material from reinforcing fiber tissue that is first cut to the shape shown in FIG. 2. This shape comprises a central portion corresponding to the hollow main body 2 and four extensions each corresponding to an arm of one of the two double yokes.

The tissue used is a carbon fiber tissue of constant thickness, of 2.5D type, i.e. comprising a plurality of superposed layers of woven fibers, which are connected to each other by additional connecting fibers.

The fabrication of this connecting rod consists generally in folding the tissue from FIG. 2 to impart a tubular general shape to it, for example, by applying it to a mandrel or the like, then injecting resin into the reinforcing fiber tissue and curing the combination to polymerize this resin.

The thickness of the yokes is increased before shaping the tissue and injecting the resin. This is achieved by cutting the connecting fibers of the 2.5D tissue at the level of the yokes so as to separate the layers of woven fibers constituting the tissue.

Additional interleaved layers are then added locally between the separated initial layers, which enables the thickness to be increased locally. After adding the interleaved layers, so-called transverse fibers are passed through the assembly to fasten all the layers together.

This solution, which enables the thickness of the composite material wall constituting the connecting rod to be locally increased at the level of the yokes nevertheless remains costly and complex to implement in a context of industrialization, because it necessitates separating the layers and interleaving new layers of woven fibers.

### OBJECT OF THE INVENTION

The object of the invention is to propose a solution to remedy this drawback by proposing a method for making a composite material connecting rod having a localized increased thickness along its main axis.

### SUMMARY OF THE INVENTION

To this end, the invention provides a method for making a composite material connecting rod, comprising the steps of:
producing a mandrel forming a rigid whole adapted to receive layers of reinforcing fibers;
alternately applying around the mandrel, on the one hand braided fiber layers extending over the whole of the length of the mandrel by being applied by a reinforcing fiber braiding machine, and on the other hand fiber layers wound around the mandrel at the level of a reinforcing portion of the connecting rod corresponding to a portion of the length of the mandrel, these wound layers being applied with a machine for winding a binding constituted of reinforcing fibers;
injecting resin into the layers of braided and wound fibers and polymerizing it to establish a cohesion rigidly connecting the braided layers to the wound layers.

The connecting rod that includes an increased thickness extending locally along its main axis is thus essentially obtained by combining simple methods, namely braiding and winding, enabling industrialization of the method with a very competitive manufacturing cost.

The method of the invention thus enables the production of a part in which the composite material thickness differs between two portions of the part spaced from each other along the main axis.

Method as defined hereinabove, further comprising a step of machining the reinforcing portion including each wound layer and each braided fiber layer to form therein an interface intended to receive a mechanical shaft connecting the connecting rod to another mechanical element.

Method as defined hereinabove, wherein the reinforcing portion is situated at one end of the connecting rod, and wherein the machining step comprises operations of milling and drilling the reinforcing fiber layers to form at the level of this end two arms of a double yoke.

Method as defined above, wherein the reinforcing portion is situated between the ends of the connecting rod and wherein the machining step comprises an operation of drilling the reinforcing fiber layers to form a bearing therein.

Method as defined above, wherein a mandrel is used having a flattened end corresponding to the reinforcing portion and wherein the machining step comprises milling and drilling operations to form at the level of this end a single yoke arm.

Method as defined above, wherein the binding used is a woven reinforcing fiber tape.

Method as defined above, wherein the binding is wound in a helix having a predetermined angle.

Method as defined above, wherein a plurality of wound layers is applied with different helix angles.

### BRIEF DESCRIPTION OF THE FIGURES

FIG. 1, already described, is a general view of a known composite material connecting rod with two double yokes;

FIG. 2, already described, is a view of the piece of reinforcing fiber tissue used to fabricate the connecting rod from FIG. 1 by a known method when flattened out;

FIG. 3 is a perspective view of a mandrel used to produce a connecting rod by the method of the invention;

FIG. 4 is a perspective view showing diagrammatically an operation of depositing a layer of braided reinforcing fibers around the mandrel in the method of the invention;

FIG. 5 is a perspective view showing diagrammatically the mandrel surrounded by a layer of reinforcing fibers braided around the mandrel;

FIG. 6 is a perspective view showing diagrammatically an operation of depositing a layer of reinforcing fibers wound around the mandrel in the method of the invention;

FIG. 7 shows in perspective a raw connecting rod body as it appears after an operation of injection of resin;

FIG. 8 shows in perspective the connecting rod produced by the method of the invention once its ends have been machined;

FIG. 9 is a diagrammatic representation in section of an example of a yoke produced by the method of the invention.

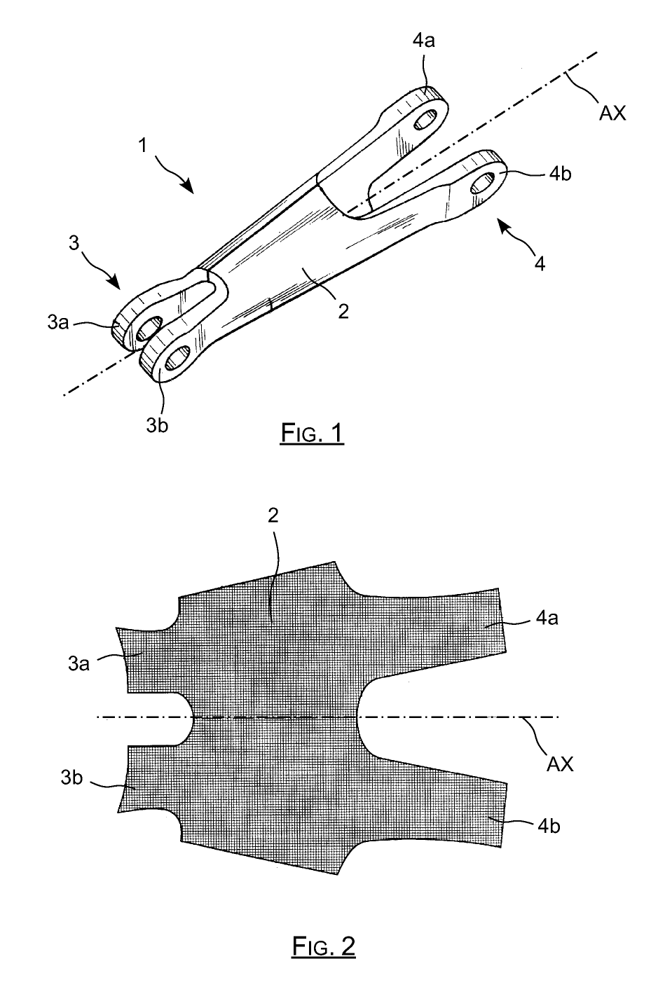

### DETAILED DESCRIPTION OF THE INVENTION

The basic idea of the invention is to produce a part in composite material formed on a mandrel by alternating operations of application of braided fiber layers around the mandrel over its entire length with operations of winding reinforcing fiber bindings wound only at the level of each reinforcing portion in order to constitute there a local increased thickness.

The braiding and winding operations are carried out successively as many times as necessary, until the required thicknesses are obtained, i.e. on the one hand the nominal thickness of the part and on the other hand the increased thickness required at the level of the reinforcing portion.

In the example shown in FIG. 3 and the subsequent figures, the mandrel 5 extends along a longitudinal axis AX, taking the form of a sleeve having a shape generally of revolution about this axis.

This shape more particularly evolves along the axis AX since in the central region 6 the cross section of the mandrel 5 is more or less circular while at the level of the first and second ends 7 and 8, respectively, the mandrel 5 has rectangular sections with different dimensions.

In the example shown in the figures, the section of the mandrel 5 at its first end 7 is significantly greater than the section of its second end 8. The first end is that coinciding with the double yoke of the connecting rod to be formed on this mandrel 5, while the second end coincides with the other yoke of this connecting rod which here is a single yoke.

In the example shown in the figures, the mandrel is a generally hollow part but the second end of which is solid, being formed of composite material to constitute the central region of the single yoke.

Two rods 9 and 11 are rigidly fastened to the ends 7 and 8 of the mandrel, extending in the longitudinal direction AX. These rods enable manipulation of the mandrel without having to grasp it by its external face and its retention in a braiding machine.

This mandrel 5 which is used to deposit layers of reinforcing fibers has the role of supporting these layers and of imparting the internal shape of the part. It is advantageously produced from layers of pre-impregnated carbon fiber tissue positioned and pre-polymerized. Pre-polymerization enables there to be imparted to this mandrel the appropriate mechanical stiffness for manipulation and seals it to prevent resin from being able to penetrate into its hollow internal space.

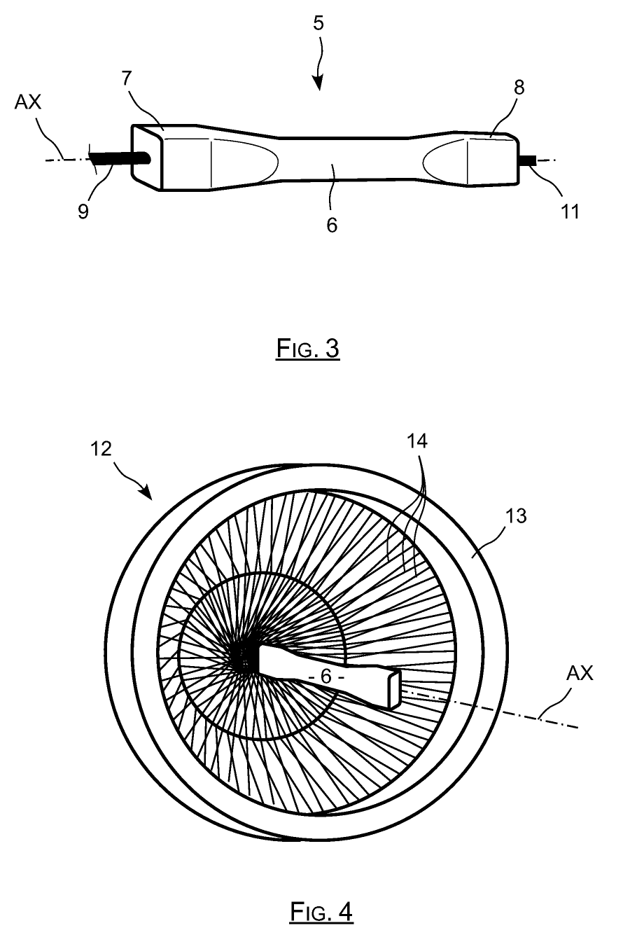

As shown in FIG. 4, once the mandrel 5 is finished, it is engaged in the braiding machine 12 in order to braid around it a first layer of reinforcing carbon fibers. This braiding machine primarily comprises a circumferential ring 13 centered on the axis AX carrying on its rear face a series of spools of carbon fibers 14.

When the mandrel 5 is moved along the axis AX through the ring 13 of the braiding machine, the whole being actuated by various controlled means, not shown, a sock of carbon fibers is braided around the external face of revolution of the mandrel 5 and pressed onto this external face.

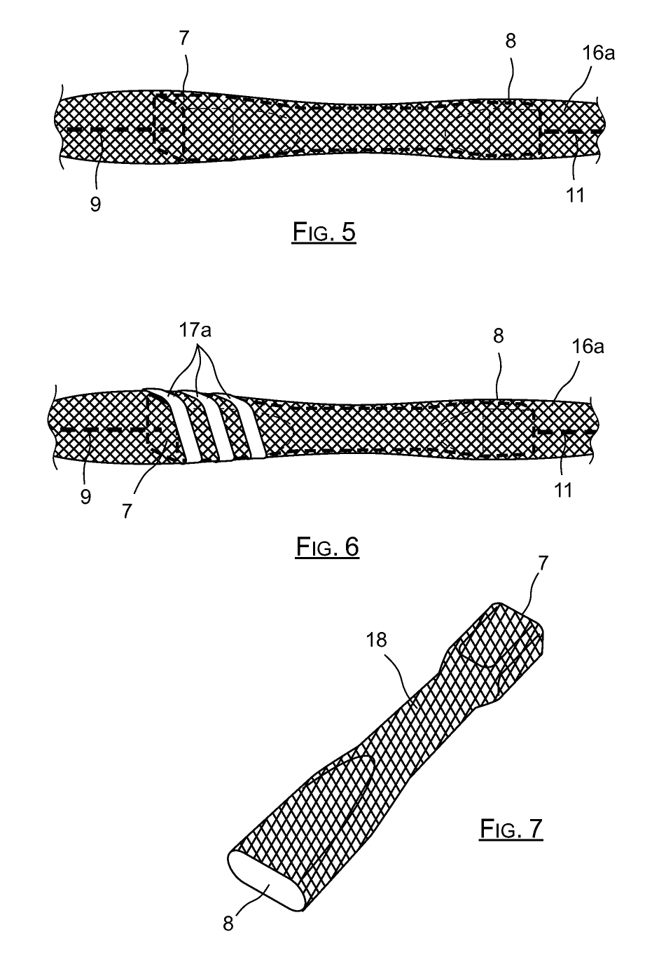

As can be seen in FIG. 5, the first layer 16a of braided carbon fibers surrounds the mandrel 5 over the entire length of the mandrel along the axis AX and extends beyond its ends 7 and 8, whilst being substantially clamped against the external face of this mandrel 5.

When this first braided layer 16a has been applied, a first tape is wound around the first end 7 of the mandrel 5, over this first braided layer 16a, to form an increased thickness locally reinforcing the connecting rod along the axis AX, here at the level of its end.

This first wound tape 17a seen in FIG. 5 enables a local increase in the thickness of material constituting the connecting rod at the level of its first end, compared to the thickness of material constituting this connecting rod in its central region.

The first end of the connecting rod coincides with the first end 7 of the mandrel 5, the central region of the connecting rod coincides with the central region 6 of the mandrel 5, and the second end of the link coincides with the second end 8 of the mandrel 5.

As shown diagrammatically in FIG. 5, the tape 17a that is wound around the first end 7 is disposed in a generally helical shape with a substantially rectangular base, conforming to the section of the end 7 of the mandrel 5 that it surrounds.

This first tape 17a is wound at a predetermined helix angle relative to the axis AX, this angle being defined to achieve the best distribution of stresses in the connecting rod end when the latter is loaded mechanically.

In FIG. 6, the tape 17a surrounds the end 7 over only three helical turns that are spaced from each other. However, a plurality of layers of tapes may be wound successively around this first end, during the same winding phase, to add to the increased thickness that is introduced in this way. The consecutive turns of the tape 17a may overlap partially, to increase the added thickness.

For example, this winding phase may incorporate a step during which the mandrel is moved one way along the axis AX followed by another step in which it is moved the opposite way along the axis AX, enabling successive constitution of oppositely oriented helixes.

It is equally possible to wind two tapes forming two helixes with opposite orientations, i.e. opposite directions, in a single part of the mandrel along the axis AX, by using two machines turning in opposite directions about the axis AX and each winding one tape.

This tape may applied manually, automatically or semi-automatically. For example, the tape may be applied by causing the mandrel to turn about the axis AX in a fixed winding machine. This winding may also be effected with a winding machine comprising a ring around the mandrel 5 adapted to pivot around the latter.

Such a ring may be mounted on a set of rollers that surround it, one of the rollers being motorized to drive the rotation of the ring. This winding ring then carries one or more spools of tape or fiber to be wound, each spool being able to turn relative to the ring that carries it about an axis parallel to the axis AX of the ring.

Under these conditions, the rotation of the ring and the movement of the mandrel along the axis AX enable winding to be carried out with a pitch and a helix angle that may be adjusted as required.

Once this first tape 17a has been wound around the first end, the whole of the mandrel 5 with the first braided layer 16a and the first wound tape 17a is again offered up in the ring 13 to braid another layer of reinforcing fibers around this assembly.

Once this second layer of reinforcing fibers has been braided around the assembly, a second tape is wound around the first end 7, in an analogous manner to the first tape, on top of this second braided layer, which makes it possible to increase further the thickness of material at the end of the connecting rod relative to the thickness of material in the central region of the connecting rod.

Different operations of application of braided layers and wound tapes are thus carried out successively up to application of the last braided layer. Where appropriate, and given the required structure, two braided layers may be contiguous, i.e. may have no interleaved wound layer between them.

The assembly constituted by the mandrel and the braided and wound layers that it carries is then installed in a dedicated molded, constituted for example of two parts each having an imprint corresponding to the exterior shape of one half of this assembly.

This mold is provided with resin injection means which are then actuated to inject resin throughout the thickness of the various braided and wound layers. The mold is then controlled to cure the assembly so as to polymerize completely the injected resin.

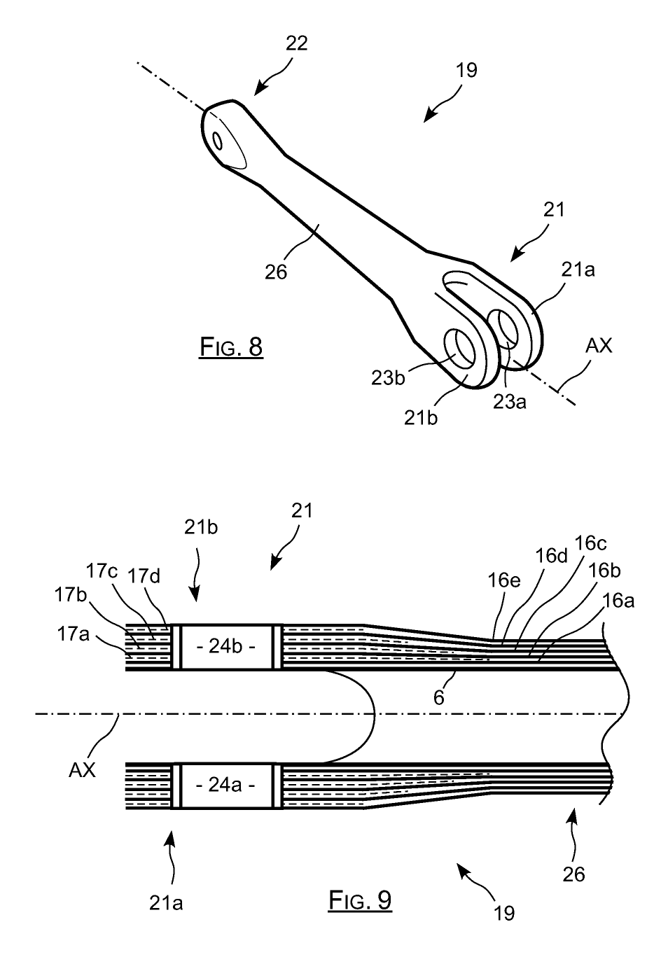

Once the polymerization is finished, the assembly is removed from the mold and constitutes a raw part 18 shown diagrammatically in FIG. 7.

This raw part 18 is then machined at the level of its ends to form the finished connecting rod 19 shown in FIG. 8, which here comprises a double yoke 21 at its first end and a single yoke 22 at its other end.

As may be seen in the figures, the double yoke 21 may for example be machined by a pass of a milling tool at the level of the first end of the raw part in a plane containing the axis AX.

This pass of the milling tool enables the formation of a groove that separates the two arms or branches 21a and 21b of the double yoke 21 from each other, which are thus spaced by a distance corresponding to the thickness of the milling tool. Additional machining is then carried out to impart to the contours of these arms 21a and 21b predefined generally rounded shapes.

In a complementary way, a drilling operation is carried out in a direction normal to the plane of the pass of the milling tool to produce in the arms 21a and 21b the two bores 23a and 23b enabling a shaft to be engaged in this double yoke when the connecting rod is mounted.

Two metal rings 24a and 24b are then mounted in the bore 23a and in the bore 23b, respectively, to distribute as uniformly as possible the mechanical stress applied by the shaft to the yoke mounted on that shaft when the assembly is loaded.

As may be seen in FIG. 9, the method of the invention enables the production of a connecting rod 19 having one end in the form of a yoke comprising two arms 21a and 21b formed of significantly greater thicknesses of composite material than the thicknesses of composite material constituting the rest of the connecting rod, and in particular its hollow main body 26.

More particularly, in the example shown in FIG. 8, a first layer of reinforcing fibers 16a has been braided around the mandrel 5 before winding a first tape 17a around this first layer 16a, but only at the level of the first end. A second layer 16b of braided fibers has then been applied before winding a second tape, again at the level of the first end. A third layer 16c of braided fibers has then been braided around the assembly thus constituted before winding a third tape 17c. A fourth layer 16d of braided fibers has then been applied over this assembly before winding a fourth tape 17d locally around the first end. A final layer 16e of braided fibers has then been braided around the assembly.

As can be seen in FIG. 9, here the thickness of the yokes is substantially twice the thickness of the material in the rest of the yoke. Generally speaking, the operations of application of braided and wound layers are repeated as many times as necessary, until the required nominal thickness and the required additional thickness in the reinforcing area are obtained.

In the example shown in the figures, the material that is wound around the first end is a reinforcing fiber binding taking the form of a woven fiber tape. However, it is equally possible to wind reinforcing fiber directly, or ribbon or a wick of reinforcing fibers. More generally, it is a matter of winding a binding produced from reinforcing fibers that are advantageously fibers of the same kind as the fibers used for the braided layers, or that are at least compatible with the fibers of the braided layers.

In addition to contributing the material that they constitute, these wound bindings enable clamping of the braided reinforcing fiber layers by pressing them firmly against the external face of the mandrel. This clamping enables the density of the reinforcing fibers to be increased in the finished part to increase its mechanical strength.

Moreover, in the example shown in the figures, the method is used to produce an increased thickness of composite material at the end of the connecting rod to form a double yoke the arms of which are sufficiently thick.

However, the invention may find applications other than the production of a double yoke having two thick arms, notably by enabling a connecting rod to be made comprising in a central region of its main body an opening or bearing through it intended to receive a mechanical shaft, or a connecting rod comprising at its end a single yoke instead of a double yoke as in the example shown in the figures.

It is thus possible to wind one or more tapes for example in a central region of the connecting rod body to increase the thickness thereof when this central region includes a bearing intended to receive a mechanical shaft of another articulated element. On the same terms as a yoke, such a bearing constitutes an interface enabling articulation of the connecting rod and another mechanical component. In this case, once the layers of reinforcing fibers, braided and wound at the level of bearing, have been applied and the resin has been injected and polymerized, an operation of drilling these layers in the direction transverse to the connecting rod enables the bearing as such to formed therein.

A single yoke may be produced at the end of the connecting rod by means of a mandrel having a cylindrical hollow main body as in the example shown in the figures but having one thin flat end.

In this case, the braided fiber layers may be applied over the whole of the length of the mandrel, while the wound layers are applied around this flattened end of the mandrel. Once all the layers have been applied, the resin is injected and polymerized, before drilling the end of the connecting rod to form therein the opening enabling a single yoke to be produced at this end. As will have been understood, this drilling is carried out in a direction normal to the plane of the flat end of the mandrel.

Thus the invention applies generally to composite material parts such as connecting rods, i.e. parts extending along a main axis and having a solid or hollow cross section delimited by a closed external contour and provided with one or more interfaces, which interfaces may interchangeably be of the bearing, single yoke or double yoke type.

1. A method for making a composite material connecting rod (19), comprising the steps of:
producing a mandrel (5) forming a rigid whole adapted to receive layers (16a-16e, 17a-17d) of reinforcing fibers (14);
alternately applying around the mandrel (5), on the one hand braided fiber layers (16a-16e) extending over the whole of the length of the mandrel (5) by being applied by moving the mandrel longitudinally in a reinforcing fiber (4) braiding machine, and on the other hand fiber layers (17a-17d) wound around the mandrel (5) at the level of a reinforcing portion of the connecting rod (19) corresponding to a portion of the length of the mandrel, these wound layers (17a-17d) being applied with a machine for winding a binding (17a-17e) constituted of reinforcing fibers;
injecting resin into the layers (16a-16e, 17a-17d) of braided and wound fibers and polymerizing it to establish a cohesion rigidly connecting the braided layers (16a-16e) to the wound layers (17a-17d).

2. The method as claimed in claim 1, further comprising a step of machining the reinforcing portion including each wound layer (17a-17d) and each braided fiber layer (16a-16e) to form therein an interface intended to receive a mechanical shaft connecting the connecting rod (19) to another mechanical element.

3. The method as claimed in claim 2, wherein the reinforcing portion is situated at one end of the connecting rod (19), and wherein the machining step comprises operations of milling and drilling the reinforcing fiber layers (17a-17d, 16a-16e) to form at the level of this end two arms of a double yoke (21).

4. The method as claimed in claim 2, wherein the reinforcing portion is situated between the ends of the connecting rod (19) and wherein the machining step comprises an operation of drilling the reinforcing fiber layers (17a-17d, 16a-16e) to form a bearing therein.

5. The method as claimed in claim 2, wherein a mandrel is used having a flattened end corresponding to the reinforcing portion and wherein the machining step comprises milling and drilling operations to form at the level of this end a single yoke arm.

6. The method as claimed in claim 1, wherein the binding used is a woven reinforcing fiber tape.

7. The method as claimed in claim 1, wherein the binding is wound in a helicoid having a predetermined angle.

8. The method as claimed in claim 1, wherein a plurality of wound layers (17a-17d) is applied with different helicoid angles.
